(19) United States
(12) Patent Application Publication
(10) Pub. No.: US 2016/0263628 A1
(43) Pub. Date: Sep. 15, 2016

(54) Cleaning device for rotary tubular object

(71) Applicant: SICHUAN WUHUAN PETROCHEMICAL EQUIPMENT CO., LTD., Jianyang (CN)

(72) Inventor: Shing Chen, Jlanyang (CN)

(21) Appl. No.: 15/158,355

(22) Filed: May 18, 2016

Related U.S. Application Data
(63) Continuation of application No. 14/355,398, filed on Nov. 10, 2014, now Pat. No. 9,342,779.

(30) Foreign Application Priority Data
Oct. 14, 2015 (CN) 201510662177.2

(51) Int. Cl. B08B 3/12; B08B 5/02; B08B 3/14

(52) U.S. Cl. CPC B08B 3/12; B08B 3/14; B08B 5/02

(57) ABSTRACT

A cleaning device for a rotary tubular object includes a reactor into which the rotary tubular object to be cleaned is inserted, a water tank containing clear water, and a centralized ultrasonic system for cooperating with the water tank to ultrasonically clean a section of the rotary tubular object to be cleaned which is located in the reactor. The centralized ultrasonic system is inserted into the reactor. The water tank is intercommunicated with a water inlet of the reactor through a flexible pipe. Water outlets of the reactor are located above the water tank. A water pump connected with the flexible pipe is arranged in the water tank. The present invention adopts the clear water to serve as a cleanser, and, after cooperating with the ultrasonic system, continuously ultrasonically cleans the rotary tubular object section by section. During cleaning, no chemical agent is applied.

### CROSS REFERENCE OF RELATED APPLICATION

The application claims priority under 35 U.S.C. 119(a-d) to CN 201510662177.2, filed Oct. 14, 2015.

### BACKGROUND OF THE PRESENT INVENTION

1. Field of Invention

The present invention relates to a cleaning device for a rotary tubular object.

2. Description of Related Arts

Conventionally, for most of the mechanical machined parts, because the coolant and the lubricant are used during machining, the contaminants are formed on the machined surface of the parts after machining. Thus, it is necessary to clean the part with the chemical agent, such as the strong acid, the strong alkali and the specific chemical, so as to remove the contaminants from the surface of the part, which causes the subsequent effluent water problem of the secondary pollution.

In order to avoid the secondary pollution caused by using the chemical agent, high-temperature hot water and high-temperature high-pressure steam which have a relatively high energy consumption are adopted to clean the contaminants, while adopting the physical ultrasound to clean the contaminants is also feasible and has an extremely good effect. The parts to be cleaned are mostly arranged in the water tank for batch cleaning. However, the ultrasonic transducer is mounted outside the water tank, which causes the ultrasonic energy in the water tank to be blocked, attenuated and separated that an energy conversion effect is not good and cleaning dead corners exist, especially for the parts to be cleaned having the surface structures, for example the finned tube. Moreover, when cleaning the machined parts, cleaning and mechanical machining are mostly separate, and thus the machined parts need to be moved for several times. The machined parts having the soft appearance are easily damaged and deformed due to being moved for several times, for example the aluminum fin at the outer side of finned tube.

### SUMMARY OF THE PRESENT INVENTION

An object of the present invention is to provide a cleaning device for a rotary tubular object, which is able to improve a cleaning effect on the object to be cleaned and meanwhile avoid a finned tube being moved for several times, so as to avoid a soft fin being damaged.

In order to accomplish the above object, the present invention adopts following technical solutions.

A cleaning device for a rotary tubular object comprises: a reactor into which the rotary tubular object to be cleaned is inserted, a water tank containing clear water, and a centralized ultrasonic system for cooperating with the water tank to ultrasonically clean a section of the rotary tubular object to be cleaned which is located in the reactor; wherein: the centralized ultrasonic system is inserted into the reactor; the water tank is intercommunicated with a water inlet of the reactor through a flexible pipe; water outlets of the reactor are located above the water tank; and a water pump which is connected with the flexible pipe is arranged in the water tank.

Preferably, the cleaning device further comprises an air nozzle which is located at an outer side of the reactor and has a nozzle outlet pointing to the rotary tubular object to be cleaned.

Preferably, the centralized ultrasonic system comprises a transducer, a booster which is connected with the transducer, and a horn which is connected with an end of the booster and located in the reactor.

Preferably, a distance between a working surface of the horn and a surface of the rotary tubular object to be cleaned is 2 mm-200 mm.

Preferably, the working surface of the horn is circular or rectangular.

Preferably, a filtering device is arranged at a water inlet of the water tank.

Preferably, an elastic gasket is arranged at each water outlet of the reactor, for slowing down a discharging velocity of the clear water in the reactor.

Compared with prior arts, the present invention has following beneficial effects.

Firstly, with a cooperation among the centralized ultrasonic system, the reactor and the water tank, the present invention ultrasonically cleans the rotary tubular object section by section, without any dead corner left. The present invention adopts the clear water to serve as a cleanser, and achieves objects of no emission and no pollution while guaranteeing the cleaning effect and not using any chemical agent, which avoids a secondary pollution to environment, guarantees safety and health of operation personnel, and has no chemical corrosion to the aluminum-sheet-type rotary tubular object with the clear water.

Secondly, the present invention adopts a clear water cycle mode of (water tank)-to-reactor-to-(water tank), which completely cleans the rotary tubular object, realizes a cyclic utilization of the clear water, and avoids a waste of water resources. Moreover, the present invention cleans the rotary tubular object at a room temperature, which avoids using high-temperature liquid and high-temperature high-pressure steam, greatly saves energy, has a significant energy saving effect, especially at a low-temperature working area, and greatly increases an energy usage efficiency.

Thirdly, the present invention is able to cooperate with machining and manufacturing of the rotary tubular object, so that a one-step production line of manufacturing and cleaning is formed. After finishing machining the rotary tubular object, the rotary tubular object is directly inserted into the reactor section by section, then each section is cleaned through the centralized ultrasonic system with cooperation of the clear water, without any dead corner left, and finally the rotary tubular object leaves the factory. Thus, an arrangement of the device is flexible, an occupied area is saved, and the number of times the rotary tubular object (such as the finned tube) needs to be moved is decreased, and a damage to the rotary tubular object is avoided; meanwhile, physical labor of workers is decreased, an injury risk of the workers is decreased, and an overall production efficiency is increased.

Fourthly, after the clear water cleaning a surface of a section of the rotary tubular object to be cleaned, some contaminants exist in the clear water. In order to further guarantee the cleaning effect on a next section of the rotary tubular object, the filtering device is arranged at the water inlet of the water tank, for filtering the clear water entering the water tank. Accordingly, continuous cleaning for the rotary tubular object is realized, and a working efficiency is increased.

Fifthly, the present invention has a simple structure, an ingenious design, a low cost, and an easy operation, without pollution and emission. Thus, the present invention has a high practical value and promotional value.

These and other objectives, features, and advantages of the present invention will become apparent from the following detailed description, the accompanying drawings, and the appended claims.

### BRIEF DESCRIPTION OF THE DRAWINGS

FIG. 1 is a structural sketch view of a cleaning device for a rotary tubular object according to a preferred embodiment of the present invention.

FIG. 2 is a structural sketch view of a reactor of the cleaning device according to the preferred embodiment of the present invention.

FIG. 3 is a first structural sketch view of a centralized ultrasonic system according to the preferred embodiment of the present invention.

FIG. 4 is a second structural sketch view of the centralized ultrasonic system according to the preferred embodiment of the present invention.

FIG. 5 is a sketch view of a using condition of the cleaning device according to the preferred embodiment of the present invention.

In figures: 1—transducer; 2—booster; 3—horn; 4—reactor; 5—flexible pipe; 6—water tank; 7—air nozzles; and 8—rotary tubular object to be cleaned.

### DETAILED DESCRIPTION OF THE PREFERRED EMBODIMENT

The present invention is further illustrated with accompany drawings and a preferred embodiment, and the preferred embodiment of the present invention is exemplary only and not intended to be limiting.

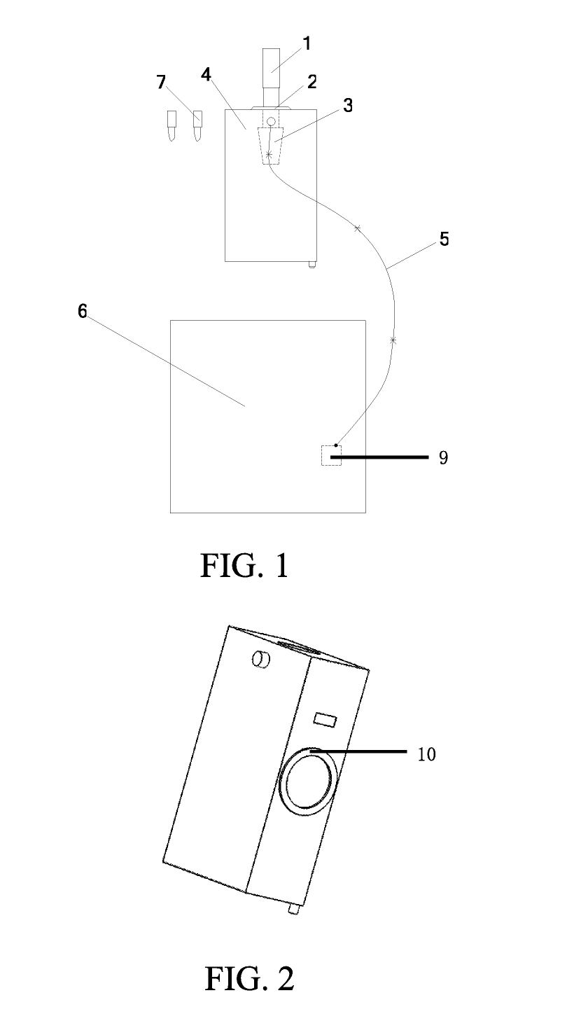

As showed in FIG. 1, according to a preferred embodiment of the present invention, a cleaning device for a rotary tubular object comprises: a centralized ultrasonic system, a reactor 4, a water tank 6 and air nozzles 7. As showed in FIG. 2, the reactor 4 is for being penetrated by the rotary tubular object so that the rotary tubular object is able to continuously move forward, and, after cooperating with the centralized ultrasonic system and the water tank 6, the reactor is able to continuously clean a section of the rotary tubular object which is located in the reactor.

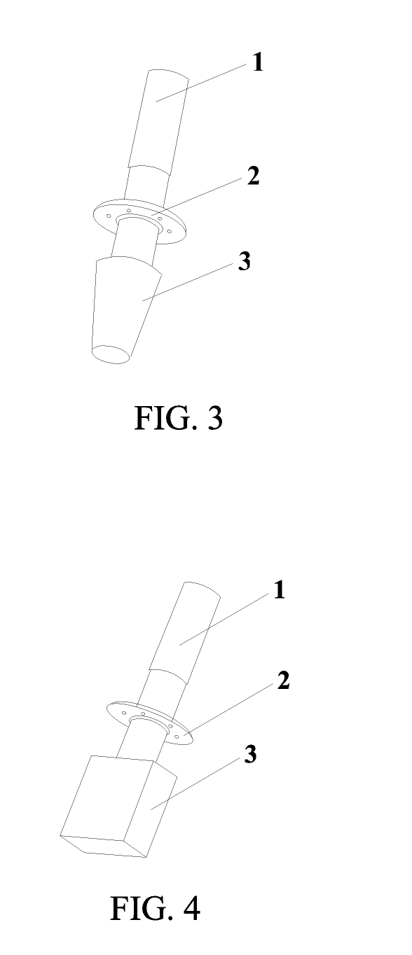

Furthermore, the centralized ultrasonic system comprises a transducer 1, a booster 2, and a horn 3; wherein: the transducer 1 is located outside the reactor 4; a first end of the booster 2 is connected with the transducer 4; the horn 3 is connected with a second end of the booster 2 and stretches into the reactor 4; and the horn 3 is located above, below, or at a lateral side of the rotary tubular object to be cleaned. As showed in FIG. 3 and FIG. 4, a working surface of the horn 3 is circular or rectangular.

Furthermore, the water tank 6 contains clear water; a water pump 9 is arranged in the water tank; a water outlet of the water pump 9 is connected with a water inlet of the reactor 4 through a flexible pipe; the water pump 9 is for pumping the clear water in the water tank 6 into the reactor 4 through the flexible pipe; and a filtering device 11 is arranged at a water inlet of the water tank 6, for filtering the clear water entering the water tank 6.

Furthermore, an elastic gasket 10 is arranged at each water outlet of the reactor 4. The elastic gasket 10 has an inner diameter of 10 mm-150 mm, and is made of rubber, plastic cement or leather. The elastic gasket 10 is able to slow down a water velocity, and meanwhile able to be moderately divided into several pieces along a radial direction or adopt a grid design. While contacting the rotary tubular object to be cleaned, the elastic gasket 10 after being divided is able to prevent the rotary tubular object from being damaged. Moreover, according to the preferred embodiment of the present invention, a water discharging port is arranged at a bottom of the reactor 4, for easily discharging oil liquid in the reactor.

The present invention continuously cleans the rotary tubular object section by section through an ultrasonic cleaning method. The ultrasonic cleaning method comprises steps of:

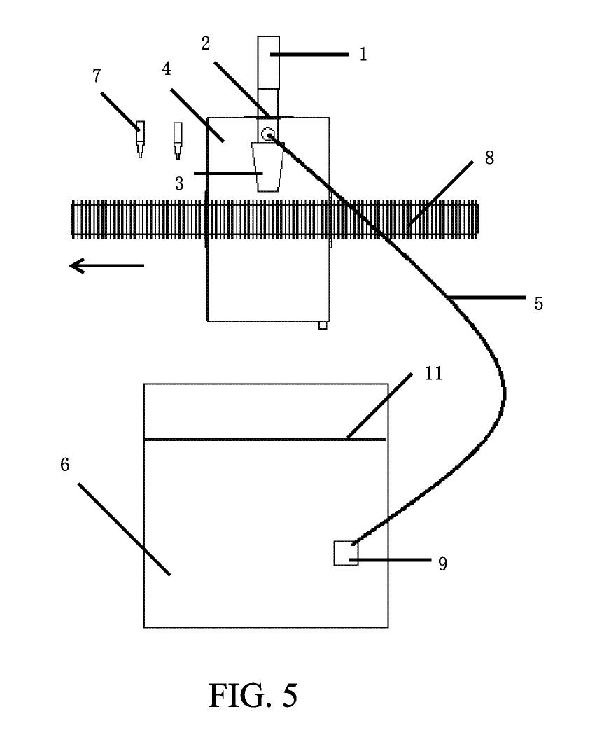

as showed in FIG. 5, opening the water pump 9 for pumping the clear water, which is filtered by the filtering device 11, in the water tank 6 into the reactor 4, wherein a height of the clear water in the reactor is over positions of the water outlets of the reactor 4; meanwhile switching on the centralized ultrasonic system, and inserting a section of the rotary tubular object 8 (such as a finned tube) to be cleaned into the reactor 4 from a side of the reactor 4; then, by the clear water, ultrasonically cleaning the section of the rotary tubular object 8 which is inserted into the reactor 4, so as to remove contaminants on a surface of the section of the rotary tubular object, and the clear water flowing back to the water tank 6 below the reactor from the water outlets of the reactor 4 through the elastic gaskets 10, wherein the horn 3 is embodied to be located 2 mm-200 mm over the rotary tubular object 8 for easily ultrasonically cleaning; after finishing cleaning, pushing a next section of the rotary tubular object 8 into the reactor, and continuing cleaning; and repeating the above steps until finishing cleaning the whole rotary tubular object.

It should be noted that, after finishing cleaning a section of the rotary tubular object, the air nozzles 7 process the section of the rotary tubular object with spraying drying, and clean residual scum on the surface of the rotary tubular object. The air nozzles 7 are located at an outer side of the reactor 4, and nozzle outlets of the air nozzles point to the rotary tubular object. An arrow showed in FIG. 5 represents a movement direction of the rotary tubular object.

Furthermore, it is feasible to arrange a plurality of the cleaning devices side by side, so as to clean the rotary tubular object for several times and further optimize a cleaning effect.

The cleaning device provided by the present invention completely cleans the rotary tubular object, without any dead corner left, and avoids a secondary pollution to environment while effectively removing the contaminants on the surface of the rotary tubular object. Therefore, the cleaning device not only well meets obligations of environmental ecological protection and responds to an environmental protection call of government, but also improves a working environment and guarantees safety and health of operation personnel. Thus, compared with prior arts, the present invention has outstanding substantive features and significant progresses.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A cleaning device for a rotary tubular object, comprising: a reactor (4) into which the rotary tubular object to be cleaned is inserted, a water tank (6) containing clear water, and a centralized ultrasonic system for cooperating with said water tank (6) to ultrasonically clean a section of the rotary tubular object to be cleaned which is located in said reactor (4); wherein: said centralized ultrasonic system is inserted into said reactor (4); said water tank (6) is intercommunicated with a water inlet of said reactor (4) through a flexible pipe (5); water outlets of said reactor (4) are located above said water tank (6); and a water pump (9), which is connected with said flexible pipe (5), is arranged in said water tank (6).

2. The cleaning device for the rotary tubular object, as recited in claim 1, further comprising an air nozzle (7) which is located at an outer side of said reactor (4) and has a nozzle outlet pointing to the rotary tubular object to be cleaned.

3. The cleaning device for the rotary tubular object, as recited in claim 1, wherein said centralized ultrasonic system comprises a transducer (1), a booster (2) connected with said transducer (1), and a horn (3) which is connected with an end of said booster (2) and located in said reactor (4).

4. The cleaning device for the rotary tubular object, as recited in claim 3, wherein a distance between a working surface of said horn (3) and a surface of the rotary tubular object to be cleaned is 2 mm-200 mm.

5. The cleaning device for the rotary tubular object, as recited in claim 3, wherein a working surface of said horn (3) is circular or rectangular.

6. The cleaning device for the rotary tubular object, as recited in claim 4, wherein said working surface of said horn (3) is circular or rectangular.

7. The cleaning device for the rotary tubular object, as recited in claim 1, wherein a filtering device (11) is arranged at a water inlet of said water tank (6).

8. The cleaning device for the rotary tubular object, as recited in claim 1, wherein an elastic gasket (10) is arranged at each water outlet of said reactor (4), for slowing down a discharging velocity of the clear water in said reactor (4).
